(19) United States
(12) Patent Application Publication
(10) Pub. No.: US 2022/0335360 A1
(43) Pub. Date: Oct. 20, 2022

(54) METHOD AND APPARATUS FOR HANDLING CITIZEN CALLBACK OF A PUBLIC-SAFETY OFFICER

(71) Applicant: MOTOROLA SOLUTIONS, INC., Chicago, IL (US)

(72) Inventors: Scott J. PAPPAS, Lake Zurich, IL (US); Jeremiah J. NELSON, Arlington Heights, IL (US); Steve MARDAKIS, Gatineau (CA); Chantal LEVERT, Ottawa (CA); Francois CREGHEUR, Gatineau (CA)

(21) Appl. No.: 17/233,738

(22) Filed: Apr. 19, 2021

(51) Int. Cl. G06Q 10/06; G06F 16/245; G06Q 50/26

(52) U.S. Cl. CPC G06Q 10/063114; G06F 16/245; G06Q 50/26

(57) ABSTRACT

A method for routing civilian calls to a public-safety officer is provided herein. During operation, a call processor receives a civilian call having a source identifier number identifying a source of the call and a target identifier number identifying a target of the call. A public-safety officer is determined that is the target of the call and a public-safety officer status database is accessed to determine a current status of the public-safety officer. When the officer is able to take the call, the call is routed directly to the officer. When the officer is unable to take the call, the officer status database is accessed, and a best available officer to take the call is determined. The call is then routed to the best available officer that is able to take the call.

### BACKGROUND OF THE INVENTION

Best policing practices operate under the assumption that community safety must be a joint venture of police and citizens. This joint venture (sometimes referred to as community policing) establishes better public relations and throttles back public skepticism of police. With community policing, citizen engagement is fostered when public-safety officers are readily available. With the above in mind, public-safety agencies want improved interactions with citizens via community policing, however limitations to these communications are needed so as not to completely disrupt police officers from performing their daily responsibilities.

Some communities give citizens the ability to “callback” officers to receive and provide updates regarding incidents. While these callbacks are encouraged to foster better communications, they can be disruptive to an officer, especially when the officer is off duty. A solution is needed to allow citizen callbacks to officers while avoiding officer disruptions.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates an operating environment for the present invention.

FIG. 2 shows a more-detailed block-diagram of call processor 107.

FIG. 3 is a flow chart showing operation of the call processor of FIG. 2.

Skilled artisans will appreciate that elements in the figures are illustrated for simplicity and clarity and have not necessarily been drawn to scale. For example, the dimensions or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions or steps may be described or depicted in a particular order of occurrence while those skilled in the art will understand that such specificity with respect to sequence is not actually required.

### DETAILED DESCRIPTION

In order to address the above-mentioned need, a method for routing civilian calls to a public-safety officer is provided herein. During operation, a call processor receives a civilian call having a source identifier number identifying a source of the call and a target identifier number identifying a target of the call. A public-safety officer is determined that is the target of the call and a public-safety officer status database is accessed to determine a current status of the public-safety officer. When the officer is able to take the call, the call is routed directly to the officer. When the officer is unable to take the call, the officer status database is accessed, and a best available officer to take the call is determined. The call is then routed to the best available officer that is able to take the call.

The determination of a best available officer may be based on one or more factors, such as, but not limited to an assigned officer to the person making the call, an emergency dispatch operator, an officer that is currently assigned to handle a past incident that involves the caller, an officer closest geographically to a past incident involving the caller, an officer closest geographically to a residence of the caller, or a specialist in incidents involving the caller.

As an example of the above, consider a situation where a student's bicycle is stolen. Officer John and Officer Smith work with the victim to file a police report. A number to reach Officer John is provided to the victim in case the victim has any future questions. Two days pass and the victim needs a copy of the police report for insurance purposes. The victim calls Officer John to find out whether anyone has found the bike and to ask for the report. If Officer John is currently off duty, Officer John will not be interrupted. Since Officer Smith was assigned to the incident along with Officer John, the call will be routed to Officer Smith. If both Officer John and Officer Smith are off duty, the call may be routed to a voice-mail system for Officer John, or alternatively, to an emergency dispatch operator.

Consider another example where a spousal abuse victim has called police on numerous occasions. Officer Jane typically handles her case and has developed a strong relationship with the victim. Officer Jane provides the victim with a callback number and instructs her to call if she needs further advice. If the victim calls Officer Jane when Officer Jane is off duty, the call may be routed to another officer based on past incident types assigned to the other officer. For example, Officer Mary may specialize in domestic violence cases. Because the victim is associated with a domestic violence incident, the call may be routed to Officer Mary, since Officer Mary specializes in such incidents.

Consider another example where Officer John and Officer Smith work with a victim of a robbery that happened at 123 Main Street. The victim lives at 234 Brown Street. A few days after the robbery, the victim calls Officer John to ask a question. If Officer John is currently off duty, Officer John will not be interrupted. Since Officer Smith was assigned to the incident along with Officer John, the call will be routed to Officer Smith. If both Officer John and Officer Smith are off duty, the call may be routed to an officer that is nearest to either the location of the robbery, or the home residence of the victim.

In order to better explain operation of handling a citizen callback of an officer, the following definitions are provided:

Incident Record (sometimes referred to as an incident report)—A digital accounting of a past public-safety incident. The digital accounting includes information such as, but not limited to a type of incident, location of the incident, address of the victim, identification of parties involved in the incident, identification of public-safety officers involved in the incident (e.g., assigned to the incident), and a time of the incident. The incident record may be generated automatically, or generated by a public-safety dispatch operator typing in information into an incident form to generate the incident record.

Public-Safety Officer Status—the current position of affairs of a public safety officer, such as, but not limited to, whether or not the officer is off duty or on duty, off break or on break, and a current location of the officer that is on duty. (Current location of an officer is typically periodically provided by an officers associated device 113 as part of normal operating procedures.)

Public-Safety Database—A database of incident records/reports.

Public-Safety Officer Status Database—A database comprising public-safety officer statuses (i.e., a database of officer statuses). This database may be populated automatically based on a work schedule for the officers, or may be populated by hand by the officers or other individuals. For example, a shared calendar may be utilized by all officers to input their time off. The shared calendar may exist within the public-safety officer status database.

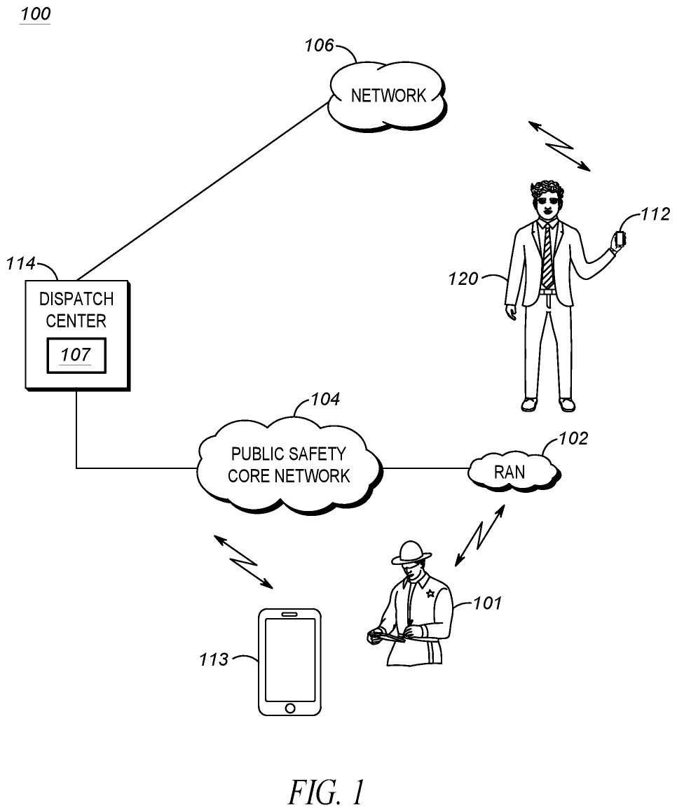

FIG. 1 illustrates a system for implementing the present invention. System 100 includes one or more radio access networks (RANs) 102, a public-safety core network 104, smart devices 112 and 113, network 106, call processor 107, and emergency dispatch center 114 serving as a PSAP.

As shown in FIG. 1, several separate networks exist, namely public-safety core network 104, and public network 106 (e.g., Verizon, Spring, AT&T, . . . , etc.). Network 106 may be wired or wireless, and comprises a standard network configured to facilitate a standard telephone call between any device 112 and dispatch center 114.

Each RAN 102 includes typical RAN elements such as base stations, base station controllers (BSCs), routers, switches, and the like, arranged, connected, and programmed to provide wireless service (such as a telephone call) to user equipment (e.g., tablet computer operated by officer 101 or smart device 113 operated by officer 101) in a manner known to those of skill in the relevant art.

In a similar manner, network 106 includes elements (which may be shared) such as base stations, base station controllers (BSCs), routers, switches, and the like, arranged, connected, and programmed to provide data and call services to user equipment 112 and/or 113 (e.g., smart phone or computers 112 and 113 operated by user 120 and officer 101) in a manner known to those of skill in the relevant art.

The public-safety core network 104 may include one or more packet-switched networks and/or one or more circuit-switched networks, and in general provides one or more public-safety agencies with any necessary computing and communication needs, transmitting any necessary public-safety-related data and communications to/from officer 101.

Smart devices 112 and 113 may be any suitable computing and communication devices configured to engage in wired or wireless communication over network 106 and/or network 104. Such communication may comprise standard cellular data. For example, smart devices 112 and 113 may comprise a mobile device running an Android™ or iOS™ operating system.

Dispatch center 114 is part of a computer-aided-dispatch center, preferably manned by an operator and configured to receive E-911 calls and/or standard telephone calls from devices 112 and 113. For non-public-safety personnel, calls are typically routed from device 112 through network 106. However, for public-safety personnel, either network 104 or 106 may be utilized by device 113 for routing calls. Calls received from device 112 at dispatch center 114 may be provided/forwarded to officer 101 (via core network 104 or network 106). For example, network 106 may receive a call from user 120 destined to officer 101 (smart device 113). Network 106 will route this call to dispatch center 114. The call may be further routed by call processor 107 to device 113 utilizing either network 104 or network 106.

Finally, call processor 107 is provided. Although processor 107 is shown existing within dispatch center 114, in alternate embodiments, processor 107 may be located outside of dispatch center 114. When located outside of dispatch center 114, processor 107 is connected to dispatch center 114 through an intervening network (e.g., networks 104 or 106). Processor 107 is configured to receive a call from device 112 destined to device 113. Processor 107 then determines a current status for officer 101 (associated with device 113). The call is forwarded to device 113 if officer 101 is on duty. If officer 101 is off duty, the call is forwarded to another officer as described above.

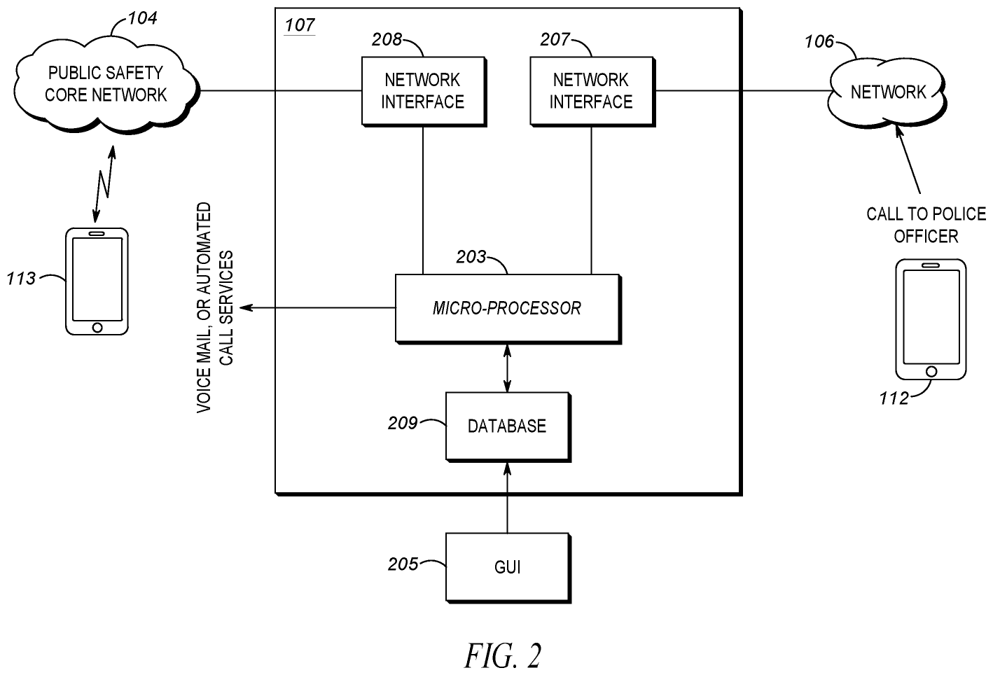

FIG. 2 shows a more-detailed block-diagram of call processor 107. Call processor 107 preferably includes network interfaces 207 and 208, memory 209, and logic circuitry 203. In other implementations, call processor 107 may include more, fewer, or different components.

Graphical user Interface (GUI) 205 serves as an interface to memory 209 and is utilized to input data into memory 209. In order to accomplish this, GUI 205 preferably comprises a screen that can display data being inserted or retrieved from memory 209. In order to provide the above features (and additional features), GUI 205 may include a monitor, a keyboard, a mouse, and/or various other hardware components to provide a man/machine interface. The GUI is preferably operated by a public-safety dispatch operator, and is used to enter data into memory 209.

Memory 209 is provided. Memory 209 comprises standard memory (such as RAM, ROM, . . . , etc) and functions as a public-safety database and public-safety officer status database. More specifically, memory 209 is configured to store incident records. Memory 209 is also configured to store public-safety officer statuses. Memory 209 is preferably populated in real time (e.g., from GUI 205) with information about incidents reported to dispatch center 114. As such, memory 209 will be coupled to a PSAP through GUI 205 so that the data may be populated.

Logic circuitry 203 comprises a digital signal processor (DSP), general purpose microprocessor, a programmable logic device, or application specific integrated circuit (ASIC) and is configured to determine what officers receive calls from particular civilians. More specifically, logic circuitry 203 is configured to receive an incoming call from a civilian and determine the identity of the calling-party, the identity of the called-party, and whether the current status for the called party. If the called party is currently off duty, the call will be forwarded to another officer as described above.

For example, if the called party is unavailable, logic circuitry 203 may route a call to another officer assigned to the person making the call, or any other officer determined as described above. During this scenario, logic circuitry 203 will access public-safety officer status database existing within memory 209 to determine if the called officer is unavailable (e.g., off work or on break). If the called officer is unavailable, logic circuitry 203 will access memory 209 to determine a most-recent incident report existing associated with the calling party to determine any officers besides the called officer that were assigned to the incident. The call may then be routed to another officer currently available that was assigned to the most-recent incident associated with the calling party. If no officer is available, the call may be routed by logic circuitry 203 to an emergency dispatch operator.

Logic circuitry 203 may route the call to an officer closest geographically to a past incident involving the caller, an officer closest geographically to a residence of the caller. For example, if the called officer is unavailable, logic circuitry 203 may access the public-safety officer status database existing within memory 209 to determine a location of all officers available to take the call. Memory 209 may also be accessed to determine a most-recent incident report involving the caller. A location of the incident and a location of the residence of the caller is obtained from the most-recent incident report. The call is then routed to an officer closest geographically to either the most-recent incident, or the residence of the caller.

Finally, when the called officer is unavailable, the call may be routed by logic circuitry 203 to a specialist for incident types related to a most-recent incident involving the caller. For example, logic circuitry may access a public-safety database existing within memory 209 to determine a most-recent incident type. A table may exist in memory 209 identifying an expert officer(s) for each incident type. Based on the most-recent incident type involving the calling party, the call may be routed to the specialist involved in handling the incident type identified in the most-recent incident report.

In an illustrative embodiment, networks 104 and 106 are attached (i.e., connected) to call processor 107 through network interfaces 207 and 208, and communicate with logic circuitry 203. Networks 104 and 106 are connected via a wired connection to network interfaces 207 and 208, although this connection may be wireless in alternative embodiments. Network interfaces 207 and 208 includes elements including processing, modulating, and transceiver elements that are operable in accordance with any one or more standard or proprietary wired or wireless interfaces, wherein some of the functionality of the processing, modulating, and transceiver elements may be performed by means of logic circuitry 203.

During operation, network interface 207 receives a civilian call from device 112 having a source identifier number identifying a source of the call and a target identifier number identifying a target of the call. The call is passed to logic circuitry 203.

Logic circuitry 203 receives the call from network interface 207 and identifies an associated public-safety officer that is the target of the call, wherein the step of identifying is based on one of the source identifier number or the target identifier number. Public-safety officer status is accessed in memory 209 by logic circuitry 203, and a current status of the associated public-safety officer is determined from the public-safety officer status database. Logic circuitry 203 then determines an appropriate officer to route the call to, as discussed above.

Considering the above discussion, FIG. 2 shows an apparatus 107 routing civilian calls to a public-safety officer, the apparatus comprises a network interface configured to receive a civilian call from a caller, the call having a source identifier number identifying a source of the call and a target identifier number identifying a public-safety officer who is a target of the call. The apparatus shown in FIG. 2 also comprises an officer status database, a public-safety database, and logic circuitry, where the logic circuitry is configured to access the officer status database to determine that the public-safety officer who is the target of the call is unavailable to take the call, access the public-safety database to determine a most-recent incident report involving the caller and the public safety officer who is the target of the call, access the incident report to determine a second officer involved with an incident identified in the incident report, access the officer status database to determine that the second officer is available, and route the call to the second officer.

As discussed above, the officer status database comprises a database of officer statuses, wherein each officer status comprises a current position of affairs of a public safety officer, including whether or not the officer is off duty or on duty.

As discussed above, the most-recent incident report comprises a digital accounting of a past public-safety incident, wherein the digital accounting includes a type of incident, a location of the incident, an address of the caller, an identification of the caller, an identification of officers involved in the incident, and a time of the incident.

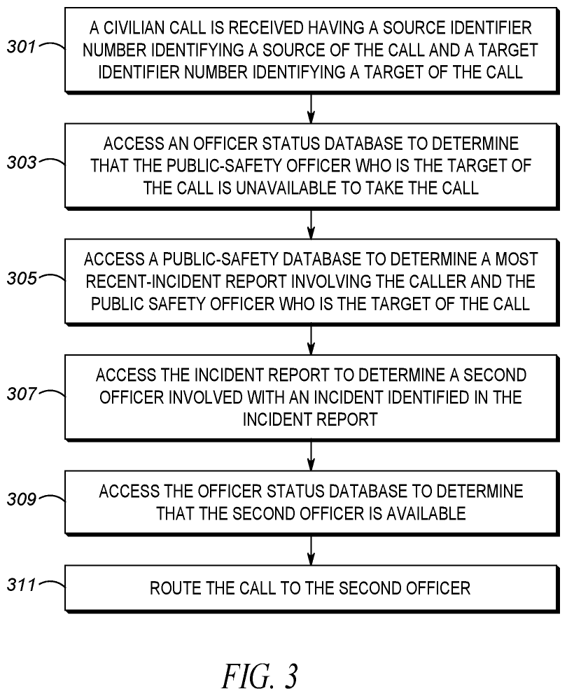

FIG. 3 is a flow chart showing the operation of call processor 107. The logic flow begins at step 301 where a civilian call is received at network interface 207 having a source identifier number identifying a source of the call and a target identifier number identifying a target of the call. At step 303 logic circuitry 203 accesses an officer status database to determine that the public-safety officer who is the target of the call is unavailable to take the call. The logic flow continues to step 305 where logic circuitry 203 accesses a public-safety database to determine a most-recent incident report involving the caller and the public safety officer who is the target of the call. The logic flow then continues to step 307 where logic circuitry 203 accesses the incident report to determine a second officer involved with an incident identified in the incident report, and then accesses the officer status database to determine that the second officer is available (step 309). Finally, logic circuitry 203 routes the call to the second officer via network interface 208 (step 311).

It should be noted that if the second officer is unavailable, logic circuitry 203 may determine a third officer that is available to handle the call, wherein the third officer is chosen based on being an officer that specializes in incidents related to an incident identified in the most-recent incident report, an officer that is closest in proximity to where the incident occurred, or an officer that is closest in proximity to an address of the caller. The call may then be routed to the third officer.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for routing civilian calls to a public-safety officer, the method comprising:
receiving a civilian call from a caller, the call having a source identifier number identifying a source of the call and a target identifier number identifying a public-safety officer who is a target of the call;
accessing an officer status database to determine that the public-safety officer who is the target of the call is unavailable to take the call;
accessing a public-safety database to determine a most-recent incident report involving the caller and the public safety officer who is the target of the call;
accessing the incident report to determine a second officer involved with an incident identified in the incident report;
accessing the officer status database to determine that the second officer is available; and
routing the call to the second officer.

2. The method of claim 1 wherein the officer status database comprises a database of officer statuses, wherein each officer status comprises a current position of affairs of a public safety officer, including whether or not the officer is off duty or on duty.

3. The method of claim 1, wherein the most-recent incident report comprises a digital accounting of a past public-safety incident, wherein the digital accounting includes a type of incident, a location of the incident, an address of the caller, an identification of the caller, an identification of officers involved in the incident, and a time of the incident.

4. A method for routing civilian calls to a public-safety officer, the method comprising:
receiving a civilian call from a caller, the call having a source identifier number identifying a source of the call and a target identifier number identifying a public-safety officer who is a target of the call;
accessing an officer status database to determine that the public-safety officer who is the target of the call is unavailable to take the call;
accessing a public-safety database to determine a most-recent incident report involving the caller and the public safety officer who is the target of the call;
accessing the incident report to determine a second officer involved with an incident identified in the incident report;
accessing the officer status database to determine that the second officer is unavailable;
determining a third officer to handle the call, wherein the third officer is chosen based on being:
an officer that specializes in incidents related to an incident identified in the most-recent incident report;
an officer that is closest in proximity to where the incident occurred; or
an officer that is closest in proximity to an address of the caller; and
routing the call to the third officer.

5. The method of claim 4 wherein the officer status database comprises a database of officer statuses, wherein each officer status comprises a current position of affairs of a public safety officer, including whether or not the officer is off duty or on duty.

6. The method of claim 4, wherein the most-recent incident report comprises a digital accounting of a past public-safety incident, wherein the digital accounting includes a type of incident, a location of the incident, an address of the caller, an identification of the caller, an identification of officers involved in the incident, and a time of the incident.

7. An apparatus for routing civilian calls to a public-safety officer, the apparatus comprising:
a network interface configured to receive a civilian call from a caller, the call having a source identifier number identifying a source of the call and a target identifier number identifying a public-safety officer who is a target of the call;
an officer status database;
a public-safety database; and
logic circuitry configured to:
access the officer status database to determine that the public-safety officer who is the target of the call is unavailable to take the call;
access the public-safety database to determine a most-recent incident report involving the caller and the public safety officer who is the target of the call;
access the incident report to determine a second officer involved with an incident identified in the incident report;
access the officer status database to determine that the second officer is available; and
route the call to the second officer.

8. The apparatus of claim 7 wherein the officer status database comprises a database of officer statuses, wherein each officer status comprises a current position of affairs of a public safety officer, including whether or not the officer is off duty or on duty.

9. The apparatus of claim 7, wherein the most-recent incident report comprises a digital accounting of a past public-safety incident, wherein the digital accounting includes a type of incident, a location of the incident, an address of the caller, an identification of the caller, an identification of officers involved in the incident, and a time of the incident.
